(19) United States
(12) Patent Application Publication
(10) Pub. No.: US 2003/0234778 A1
(43) Pub. Date: Dec. 25, 2003

(54) Apparatus for and method of reducing energy consumption

(75) Inventor: Jae-Hyun Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/422,993

(22) Filed: Apr. 25, 2003

(30) Foreign Application Priority Data
Jun. 22, 2002 (KR) 2002-35159

(51) Int. Cl. G09G 5/00

(52) U.S. Cl. 345/204

(57) ABSTRACT

An apparatus for and a method of controlling a brightness and energy consumption of a back light in a portable display. A determination is made whether an input voltage of the portable display is provided by a DC power source or batteries and a control voltage is adjusted to control a duty cycle of a pulse width modulator which supplies power to the back light based on the determination. An initial value of the control voltage may be initially set according to power provided by one of the DC voltage source and the batteries so that the control voltage is automatically changed where the input voltage is provided from the other of the DC voltage source and the batteries.

### BACKGROUND OF THE INVENTION

This application claims the priority of Korean Patent Application No. 2002-35159, filed Jun. 22, 2002 in the Korean Intellectual Property Office, the disclosure of which is incorporated herein by reference.

1. Field of the Invention

The present invention relates to an apparatus for and a method of operating a portable display device, and more particularly, to an apparatus for and a method of reducing energy consumption of a battery operated portable display device by adjusting a brightness of a back light.

2. Description of the Related Art

As portable display devices are widely used, reducing an energy consumption, which is directly related to a playing time of the portable display devices, has become a concern. In particular, since most portable display devices having screens use liquid crystal displays (LCDs), which consume a large amount of energy, the portable display devices using LCDs contradict a need for reducing energy consumption. Thus, an inverter control technique of adjusting the brightness of the back light, which consumes a great portion of the energy consumed by the LCD, is necessary. When operating the portable display devices using a direct current (DC) power source derived from a commercial energy supply, the energy consumption is not a significant problem; however, when operating the portable display devices using batteries, the energy consumption should be reduced.

FIG. 1 is a block diagram illustrating a structure of a conventional back light driving device which is formed of a brightness adjusting unit 100, an inverter 101, a transformer 102, and an LCD 103 including a back light 103-1. The inverter 101 generates a pulse width modulation (PWM) waveform and a pulse frequency modulation (PFM) waveform in correspondence to a brightness adjusting signal and supplies the waveforms to the transformer 102. The back light 103-1 is located behind the LCD 103 and provides illumination in order for a user to clearly recognize images on the LCD 103. The transformer 102 supplies power to the back light 103-1 using the PWM waveform, which is output from the inverter 101. The brightness adjusting unit 100 adjusts an input voltage Vcc by using a variable resistor VR1 and outputs a brightness adjusting voltage signal to the inverter 101.

When the input voltage Vcc is lowered, a PWM frequency output from the inverter 101 is reduced and a duty ratio is increased, so the amount of current flowing to the back light 103-1 is increased. Here, a battery outputs a voltage level equal to or less than a DC voltage level of power being supplied from the DC power source. In addition, when using batteries, the voltage level output from the battery is gradually lowered as energy stored in the battery is depleted. Accordingly, when batteries are used to operate the portable display device, the amount of current flowing to the back light 103-1 is increased compared to the case where the DC power source is used, so battery life is reduced.

### SUMMARY OF THE INVENTION

The present invention provides an apparatus for and a method of reducing energy consumption by controlling a brightness of a back light in a battery operated portable display device.

According to an aspect of the present invention, an apparatus for reducing energy consumption in a portable display device having a back light which provides illumination for a display of the portable display device comprises: a determination unit, which determines whether a voltage of a power source, which drives the portable display device, is lowered by checking the power source for a predetermined period; and a back light driving control unit, which controls a driving current of the back light to maintain a brightness of the back light to be constant where the voltage of the power source is lowered.

According to an aspect of the present invention, the back light driving control unit may comprise a brightness adjusting unit, which outputs a brightness adjusting signal to maintain the brightness of the back light to be constant where the voltage of the power source is lowered; and a back light driving unit, which controls and outputs the driving current of the back light to maintain the brightness of the back light to be constant, in response to the brightness adjusting signal.

According to an aspect of the present invention, the constant brightness and current maintained in the back light driving control unit may be a reference brightness and current, respectively, as supplied from a constant voltage power source.

According an aspect of the present invention, a method of reducing energy consumption in a portable display device comprises determining whether a voltage of a power source is lowered by checking the power source, which operates the portable display device, for a predetermined period; and controlling a driving current of a back light to be constant to maintain a constant brightness of the back light, which provides illumination for a display of the portable display device, if it is determined that the voltage of the power source is lowered.

According to an aspect of the present invention, the constant brightness and the constant driving current of the back light may be a reference brightness and a reference current as provided by a power source which provides a constant voltage.

According to an aspect of the present invention, where the voltage of the power source is lowered, the method may further comprise outputting a back light brightness adjusting signal to maintain the brightness of the back light to be constant and controlling the driving current to maintain the brightness of the back light to be constant in response to the back light brightness adjusting signal.

According to an aspect of the present invention, where the voltage of the power source is constant, the method may further comprise (b-1b) outputting a back light brightness adjusting signal to maintain a present brightness and maintaining the driving current of the back light in response to the back light brightness adjusting signal.

Additional aspects and/or advantages of the invention will be set forth in part in the description which follows, and, in part, will be obvious from the description, or may be learned by practice of the invention.

### BRIEF DESCRIPTION OF THE DRAWINGS

The above and/or other aspects and advantages of the present invention will become more apparent by describing in detail an embodiment thereof with reference to the attached drawings in which:

FIG. 1 is a block diagram illustrating a structure of a conventional back light driving device;

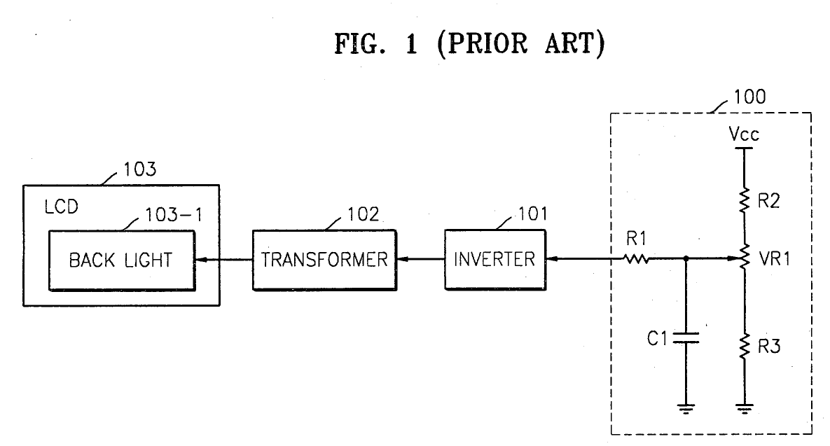

FIG. 2 is a block diagram illustrating a structure of an apparatus for reducing energy consumption according to an embodiment of the present invention;

FIG. 3 is a detailed diagram illustrating a brightness adjusting unit and a battery detection unit of FIG. 2;

FIGS. 4A through 4C illustrate waveforms for explaining the apparatus for reducing the energy consumption of FIG. 2; and

FIG. 5 is a flowchart illustrating a method for reducing energy consumption according to the present invention.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

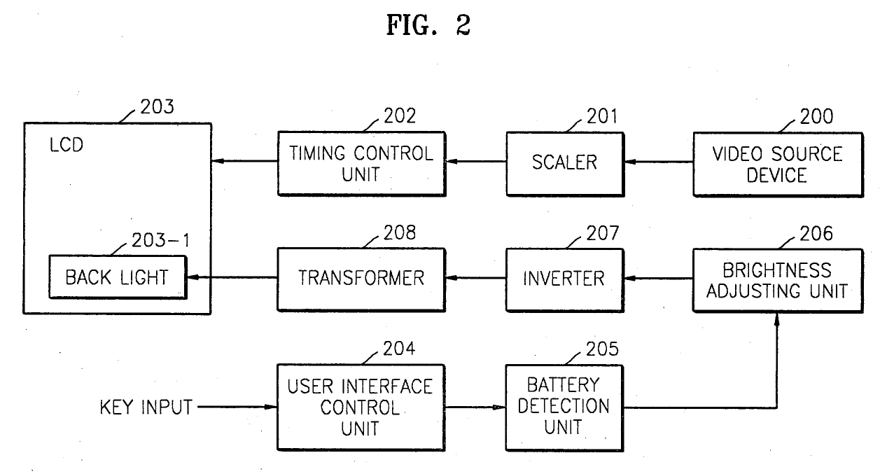

FIG. 2 is a block diagram illustrating a structure of a display device incorporating an apparatus for reducing energy consumption according to the present invention. The display device comprises a video source device 200, a scaler 201, a timing control unit 202, a liquid crystal display (LCD) 203 having a back light 203-1, a user interface control unit 204, a battery detection unit 205, a brightness adjusting unit 206, an inverter 207, and a transformer 208.

The video source device 200 generates video sources and processes the video sources into video signals to be displayed. Examples of the video source device 200 include video processors such as, for example, a DVD player, a camcorder, and a laptop computer. The scaler 201 adjusts the video signals, which are output from the video source device 200, according to a scale of the LCD 203. The timing control unit 202 holds the video signals output from the scaler 201 and outputs the video signals to the LCD 203.

The user interface control unit 204 displays reproduction information such as, for example, inputs of front keys and remote controller keys, which are arranged for an interface between a user and the portable display device, or a reproduction time on a fluorescence light tube (FLT) (not shown). In addition, the user interface control unit 204 determines whether the portable display device is operated using a DC power source or batteries. When the portable display device is operated using the DC power source, the level of a power supply voltage is constant; however, when the portable display device is operated using batteries, the level of the power supply voltage gradually decreases. Thus, the user interface control unit 204 may determine whether the portable display is operated using the DC power source or batteries by checking for the level of the power supply voltage for a predetermined period.

The battery detection unit 205 detects a power source determination signal, i.e., a signal indicating whether the portable display device is operated using the DC power source or batteries, output from the user interface control unit 204 to control the output of the brightness adjusting unit 206.

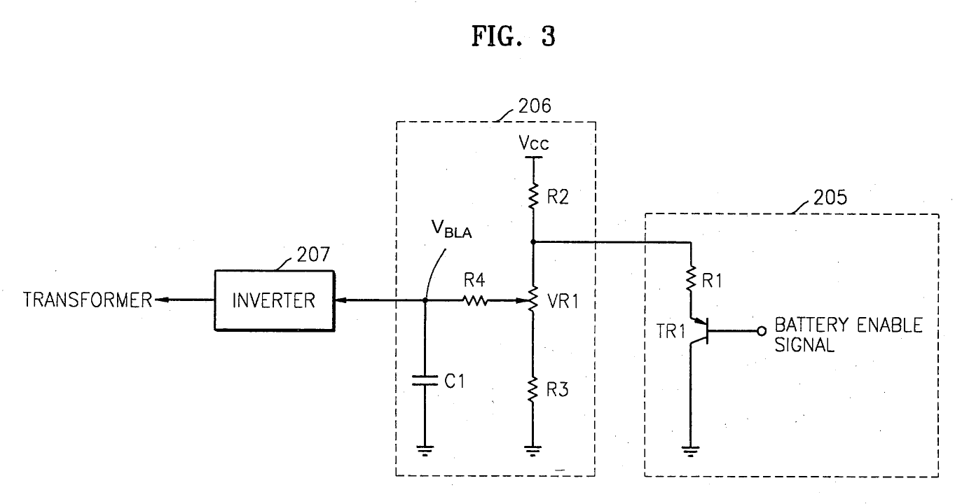

The brightness adjusting unit 206 outputs a back light brightness adjusting signal having a level which responds to the determination signal from the battery detection unit 205. Referring to FIG. 3, the brightness adjusting unit 206 attenuates an input voltage Vcc and outputs a back light brightness adjusting signal VBLA. When the battery detection unit 205 outputs a determination signal indicating that a battery is present, the driving current of the back light 203-1 increases, so the brightness adjusting unit 206 outputs the back light brightness adjusting signal for lowering the driving current of the back light 203-1 to the driving current of the back light 203-1 of the DC power source level. When the battery detection unit 205 outputs the determination signal indicating that DC power is present, the brightness adjusting unit 206 maintains the brightness and the driving current of the back light 203-1 at a predetermined level.

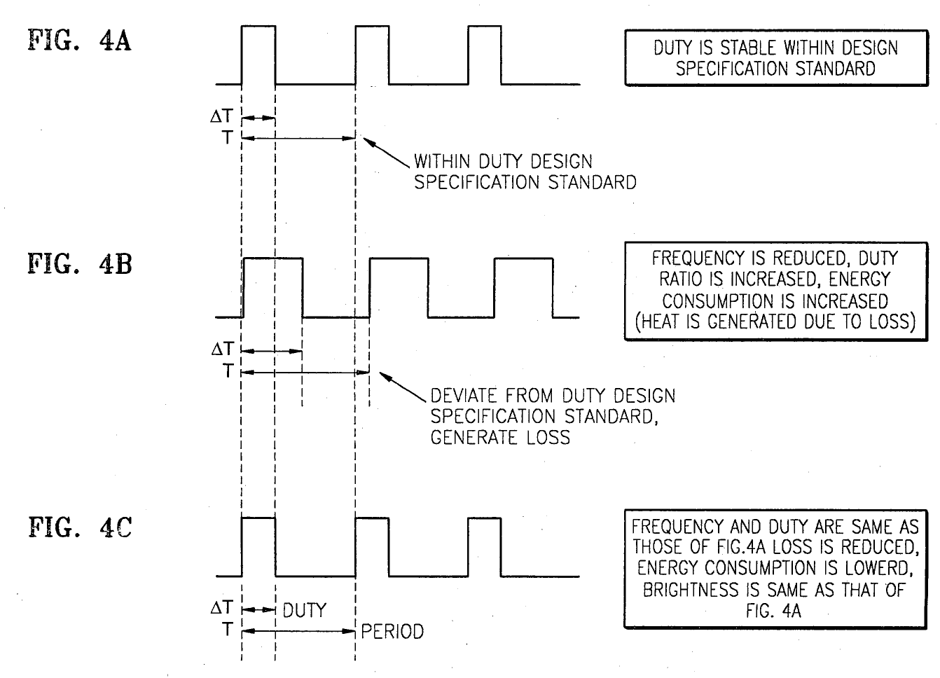

The inverter 207 generates the PWM waveform for adjusting the brightness of the back light 203-1 corresponding to the brightness adjusting signal from the brightness adjusting unit 206 and outputs the PWM waveform to the transformer 208. When the input voltage Vcc is lowered, the PWM frequency output from the inverter 207 is reduced (i.e., a period T is increased) and a duty ratio (ΔT/T) is increased by an amount which is proportional to the reduction in the input voltage Vcc, so an amount of current used is increased as shown in FIG. 4B. In addition, the inverter 207 checks for the state of the back light 203-1 to perform a shutdown function for preventing the portable display device from being damaged by over current.

The transformer 208 modulates the PWM waveform output from the inverter 207 to operate the back light 203-1.

Referring to FIG. 3, when the portable display device is operated using the DC power source, the battery detection unit 205 outputs a low level battery enable signal to the brightness adjusting unit 206. The low level battery control signal causes the transistor TR1 to turn On, placing a resistor R1 in parallel with a series combination of a variable resistor VR1 and a resistor R3. The input voltage Vcc is thus attenuated based on the resistor R2 and a parallel combination of R1 and (VR1+R3). The variable resistor VR1 may then be adjusted to establish a reference level for the back light brightness adjusting signal V_{BLA} which is provided to the inverter 207. When the portable display device is operated using batteries, the user interface control unit 204 outputs the power source determination signal to the battery detection unit 205. Accordingly, the battery detection unit 205 outputs the high level battery enable signal. When the battery enable signal is at the high level, the transistor TR1 is turned Off and the input voltage Vcc, is attenuated based on R2 and (VR1+R3) to provide the back light brightness adjusting signal VBLA. With the transistor TR1 turned Off, the attenuation is reduced and the back light brightness adjusting signal V_{BLA} increases. As a result, the brightness of the back light 203-1 where batteries are used is equal to the brightness of the back light 203-1 where the DC power source is used. In other words, the brightness of the back light 203-1 is kept uniform, regardless of whether batteries are used or the DC power source is used by the back light brightness adjusting signal V_{BLA} from the brightness adjusting unit 206. The back light brightness adjusting signal V_{BLA}, which is initially adjusted using the DC power source and the brightness adjusting unit 206, is adjusted by the brightness adjusting unit 206 in response to the battery enable signal, output to the inverter 207, and the inverter 207 lowers the duty ratio of the PWM modulation i.e., the back light brightness signal, corresponding to the adjusted back light brightness adjusting signal V_{BLA}. When the duty ratio of the PWM modulation is lowered stably, the driving current of the back light 203-1 is reduced, which lowers the energy consumption, and the brightness of the back light 203-1 where batteries are used becomes the same as the brightness of the back light 203-1 where the DC power source is used. Alternatively, the variable resistor VR1 may be adjusted while the battery enable signal is at the low level.

When a signal is input from the user interface control unit 204 indicates a DC power source is again being used, the battery detection unit 206 outputs the low level battery enable signal. When the battery enable signal is at the low level, the transistor TR1 is again turned On and the input voltage Vcc is attenuated based on the resistor R2 and a parallel combination (VR1+R3) and R1 to output the voltage V_{BLA}, to control the brightness of the back light 203-1. As a result, the back light brightness adjusting signal output to the inverter 207 is maintained at a predetermined level. The adjusted driving current of the back light 203-1 is output to the inverter 207, and the inverter 207 outputs a PWM waveform having a stable duty ratio within a design specification standard in response to the brightness adjusting signal V_{BLA}.

FIG. 4A illustrates a PWM waveform generated in the inverter 207 when the portable display device is operated using the DC power source. Here, the PWM waveform of FIG. 4A has the stable duty ratio (ΔT/T) that is within the design specification standard.

FIG. 4B illustrates a PWM waveform generated in the inverter 207 when the portable display device is operated using batteries. Here, the level of the input voltage is gradually lowered in the case where the portable display device is operated using batteries. When the level of the input voltage is lowered, the PWM frequency is reduced (T is increased), the duty ratio (ΔT/T) is increased, and the amount of current flowing to the back light 203-1 is increased. That is, the PWM frequency output from the inverter 207 is gradually reduced and the duty ratio(ΔT/T) is gradually increased so that the back light 203-1 requires an increasingly larger amount of energy.

FIG. 4C illustrates a PWM waveform generated in the inverter 207 when the apparatus for reducing energy consumption is applied to the portable display device being operated using batteries. Referring again to FIG. 3, when the battery enable signal is at the low level, the transistor TR1 is turned On and the brightness adjusting signal V_{BLA} obtained by dividing the input voltage Vcc is reduced. As a result, the brightness of the back light 203-1 to the inverter 207 is made equal to the brightness of the back light 203-1 in the case where the DC power source is used. In other words, the brightness of the back light 203-1 is the same, regardless of whether batteries are used or the DC power source is used, by controlling the brightness adjusting signal VBLA from the brightness adjusting unit 206. The back light adjusting signal, which is adjusted to the signal in the case of using the DC power source by the brightness adjusting unit 206, is output to the inverter 207, and the inverter 207 lowers the duty ratio of the PWM as the back light brightness signal corresponding to the adjusted brightness adjusting signal. When the duty ratio of the PWM is lowered stably, the driving current of the back light 203-1 is reduced, which lowers the energy consumption and the brightness of the back light 203-1 becomes the same as the brightness of the back light 203-1 in the case where the DC power source is used.

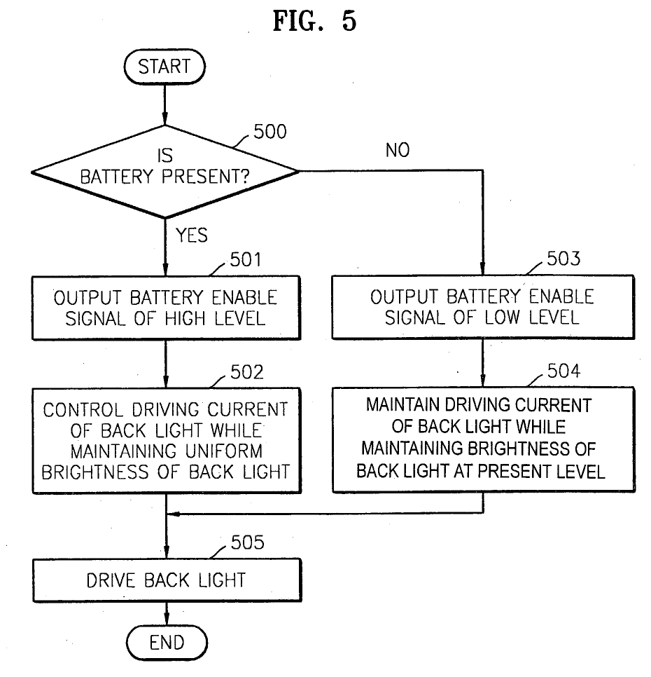

A method of reducing energy consumption will now be described with reference to FIG. 5. FIG. 5 is a flowchart illustrating a method for reducing energy consumption according to the present invention. Here, the method for reducing energy consumption comprises determining whether a battery is present in operation 500. If a battery is determined to be present in operation 500, the method further comprises, outputting a battery enable signal in operation 501, controlling a driving current of a back light while maintaining the brightness of the back light in operation 502 in response to the battery enable signal and driving the back light in response to the controlled driving current in operation 505. If a battery is determined not to be present in operation 500, the method further comprises, outputting a high level battery enable signal in operation 503, maintaining the driving current of the back light while maintaining the brightness of the back light in operation 504, and driving the back light at the present level in step 505.

The determining of whether a battery is present in operation 500 comprises checking a level of the power supply voltage for a predetermined period.

If it is determined that the portable display device is operated using batteries, the method further comprises outputting a battery enable signal having a first predetermined level and adjusting a brightness adjusting signal in response to the battery enable signal to maintain the brightness a display.

If it is determined that the portable display device is being operated using the DC power source at operation 500, the method further comprises outputting the battery enable signal having a second predetermined level and maintaining a brightness adjusting signal at a predetermined value in response to the battery enable signal to maintain the brightness a display.

According to the present invention, when the portable display device is operated using batteries, the brightness of the back light, which consumes a large portion of the energy consumed by the LCD, is adjusted, so the energy consumption is reduced and the lifetime of the batteries is increased.

While this invention has been particularly shown and described with reference to embodiments thereof, it will be understood by those skilled in the art that various changes in form and details may be made therein without departing from the spirit and scope of the invention as defined by the appended claims.

What is claimed is:

1. An apparatus for reducing energy consumption in a portable display device having a backlight which provides illumination for a display of the portable display device, the apparatus comprising:
a determination unit, which determines whether a voltage of a power source, which drives the portable display device, is lowered by checking the power source for a predetermined period; and
a back light driving control unit, which controls a driving current of the back light to maintain the brightness of the back light to be constant where the voltage of the power source is lowered.

2. The apparatus of claim 1, wherein the back light driving control unit comprises:
a brightness adjusting unit, which outputs a brightness adjusting signal to maintain the brightness of the back light to be constant in the case where the voltage of the power source is lowered; and
a back light driving unit, which controls and outputs the driving current of the back light to maintain the brightness of the back light to be constant, in response to the brightness adjusting signal.

3. The apparatus of claim 1, wherein the constant brightness and current maintained in the back light driving control unit are a reference brightness and a reference current determined at a constant voltage of the power source.

4. A method for reducing energy consumption when operating a portable display device, the method comprising:
determining whether a voltage of a power source is lowered by checking the power source, which operates the portable display device, for a predetermined period; and
controlling a driving current of a back light to be constant to maintain the brightness of a back light, which provides illumination for the display of the portable display device, if determined that the voltage of the power source is lowered.

5. The method of claim 4, wherein the controlling of the driving current comprises establishing a reference brightness and a reference current at a constant voltage of the power source.

6. The method of claim 4, wherein the controlling of the driving current comprises:
outputting a back light brightness adjusting signal to maintain the brightness of the back light to be constant; and
controlling the driving in response to the back light brightness adjusting signal.

7. The method of claim 4, wherein:
where the voltage of the power source is determined not to be lowered, the method further comprises:
outputting a back light brightness adjusting signal having a predetermined value; and
maintaining the driving current of the back light in response to the back light brightness adjusting signal having the predetermined value.

8. A portable display device selectively operable from a DC voltage source or a battery, the portable display device comprising, comprising:
a video source device which generates video signals;
a display device which displays the video signals, the display device further comprising a backlight which provides illumination for the display device;
a user interface control unit which determines whether an input voltage is provided by the DC voltage source or the battery;
an inverter which inverts the input voltage to provide a pulse width modulated (PWM) voltage to drive the backlight, the PWM voltage having a duty cycle variable according to a value of a control voltage; and
a brightness adjusting unit which varies the value of the control voltage in response to the determination of whether the input voltage is provided by the DC voltage source or the battery.

9. The portable display device of claim 8, wherein the interface control unit determines whether the input voltage is provided by the DC voltage source or the battery by checking the input voltage for a predetermined period of time.

10. The portable display device of claim 8, wherein the brightness adjusting unit comprises:
a first circuit which enables an adjustment of an initial value of the control voltage.

11. The portable display device of claim 10, wherein the brightness adjusting unit further comprises:
a second circuit which alters the control voltage from the initial value in response to the determination that the input voltage is being supplied by the battery.

12. The portable display device of claim 10, wherein the first circuit comprises:
a voltage divider which divides the input voltage and provides the control voltage according to an attenuation of the voltage divider.

13. The portable display device of claim 12, further comprising a second circuit which decreases the attenuation of the voltage divider in response to the determination that the input voltage is being supplied by the battery.

14. The portable device of claim 13, wherein:
the voltage divider comprises a first resistance, a variable resistance and a second resistance the control voltage is provided from a point along the variable resistance; and
the second circuit comprises a third resistance selectively connectable in parallel with a series combination of the variable resistance and the second resistance.

15. A method of controlling a brightness and an energy consumption of a back light in a portable display, the method comprising:
setting a duty cycle of a pulse width modulator at a predetermined value to drive the backlight of the display using a control voltage which is determined by an input voltage having a first value; and
automatically adjusting the control voltage to adjust the duty cycle to the predetermined value where the input voltage changes to a second value.

16. A method of controlling a brightness and an energy consumption of a back light in a portable display, the method comprising:
setting a brightness level of the backlight of the display using an input voltage having a predetermined value;
sensing a change in the input voltage; and
adjusting the brightness level of the backlight in response to the sensed change in the input voltage.
